(19) United States
(12) Patent Application Publication
(10) Pub. No.: US 2017/0268231 A1
(43) Pub. Date: Sep. 21, 2017

(54) METHOD OF JOINING PANELS WITH FLOW DRILL SCREWS AND AN ADHESIVE TO FORM AN ASSEMBLY

(71) Applicant: FORD GLOBAL TECHNOLOGIES, LLC, Dearborn, MI (US)

(72) Inventors: Amanda Kay FREIS, Ann Arbor, MI (US); Thomas NORTON, Ann Arbor, MI (US); Garret Sankey HUFF, Ann Arbor, MI (US)

(21) Appl. No.: 15/074,437

(22) Filed: Mar. 18, 2016

(51) Int. Cl. E04C 2/08; B29C 65/56; B29D 99/00; B29C 65/48

(52) U.S. Cl. CPC E04C 2/08; B29C 65/48; B29C 65/562; B29D 99/001

(57) ABSTRACT

A method of joining a first panel and a second panel with an adhesive and flow drill screws is provided. The adhesive is applied in a continuous strip and the flow drill screws are inserted through the first panel, the continuous strip of adhesive, and through a second panel. Material displaced by the flow drill screw forms a collar. An intermediate portion of the collar defines a bond gap for the adhesive between the panels. An assembly is made according to the method includes the intermediate collar portion formed by the flow drill screw displacing material from the panels that sets a bond gap between the first and second panels for the adhesive.

### TECHNICAL FIELD

This disclosure relates to a method of joining panels by applying an adhesive to the panels and driving flow drill screws through the panels and adhesive.

### BACKGROUND

Flow drill screws are used to join panels together and may be used in conjunction with an adhesive that improves the performance of the joint between the panels.

Referring to FIG. 1, flow drill screws 10 have a tip 12 that is rapidly rotated to form a hole 14 in a first panel 16 and a second panel 18 by locally melting the panel 16 while applying pressure. Threads 20 may be integrally formed in a collar 22 formed by removed material that extends from the head 24 of the flow drill screw 10 and through the hole 14 formed in the panels 16, 18 to be joined. Material removed by the flow drill screw 10 accumulates between and on the insertion side and exit side of the stack of panels to be joined that forms the collar 22. Especially in the case of thick panels that are joined with a flow drill screw, excess material deposited between the panels can result in an objectionable gap 26 being formed between the panels.

Referring to FIGS. 2 and 3, flow drill screws 10 were previously used with an adhesive 28 to join an insertion side panel 16, or first panel, to a second panel 18 that receives the flow drill screw 10 after penetrating the insertion side panel 16. It was previously considered to be necessary to form a clearance hole 30 in the insertion side panel 16 to avoid a large gap between thick panels. Adhesive 28 is applied between the first panel 16 and the second panel 18 to increase the strength of the joint, but adhesive application is avoided around the clearance hole 30 to avoid contaminating the flow drill screw gun (not shown) with adhesive 28 that can be squeezed through the clearance hole 30 around the flow drill screw 10 where indicated by arrows “A” in FIG. 3. Adhesive 28 is applied in a strip 32 between flow drill screw 10 insertion locations, but the strip 32 of adhesive 28 must be interrupted around the clearance hole 30 to avoid adhesive contamination of the gun and, as a result, complicates the adhesive application process.

Another problem encountered when joining panels 16, 18 with flow drill screws 10 and adhesive 28 is that insufficient space may be provided for the adhesive around the clearance hole 30 in which the flow drill screw 10 is inserted. When the flow drill screw 10 is inserted, the panels 16, 18 are squeezed together. A gap must be maintained for a sufficient deposit of adhesive between the panels for effective adhesive bond development.

This disclosure is directed to solving the above problems and other problems as summarized below.

### SUMMARY

According to one aspect of this disclosure, a method is disclosed for joining panels that includes the steps of selecting a first panel and a second panel and applying an adhesive in a continuous strip between the first and second panels. A flow drill screw is inserted through the first panel, the adhesive and the second panel. A collar is formed around the flow drill screw from the material displaced by the flow drill screw during the insertion process that defines a bond gap for the adhesive between the first and second panels.

According to other aspects of this disclosure, the flow drill screw may be inserted into a portion of the first panel that does not define a hole. The first and second panels may be aluminum sheet metal panels. The adhesive may be a structural adhesive that is cured in an oven.

The material displaced by the flow drill screw in the forming step moves the adhesive away from the flow drill screw and into the bond gap. The bond gap between the first and second panels may have a depth that is controlled by the formation of the collar. The collar extends from an insertion surface of the first panel, between the first and second panels.

According to another aspect of this disclosure, an assembly is disclosed that includes a first panel assembled to a second panel with a flow drill screw. An adhesive is deposited between the first and second panels and a flow drill screw is inserted through the first panel, the adhesive deposit and the second panel. A collar is formed around the flow drill screw that includes an intermediate collar portion having a height that sets a bond gap between the first and second panels for receiving the adhesive.

The intermediate collar portion separates the adhesive from the flow drill screw. The bond gap between the first and second panels has a depth that corresponds to the length of the intermediate collar between the first and second panels.

The above aspects of this disclosure and other aspects will be described below with reference to the attached drawings.

### BRIEF DESCRIPTION OF THE DRAWINGS

FIG. 1 is a cross-sectional view of a flow drill screw securing two panels together without an adhesive according to the prior art.

FIG. 2 is an exploded cross-sectional view of two panels prior to being joined together by a flow drill screw and adhesive according to the prior art.

FIG. 3 is a cross-sectional view of two panels being secured together by a flow drill screw and adhesive according to the prior art.

FIG. 4 is an exploded cross-sectional view of two panels in position to be joined together with a flow drill screw and a continuous strip of adhesive in accordance with one embodiment of this disclosure.

FIG. 5 is a cross-sectional view showing two panels being joined together by three flow drill screws and an adhesive contained in an adhesive gap in accordance with the embodiment of this disclosure shown in FIG. 4.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

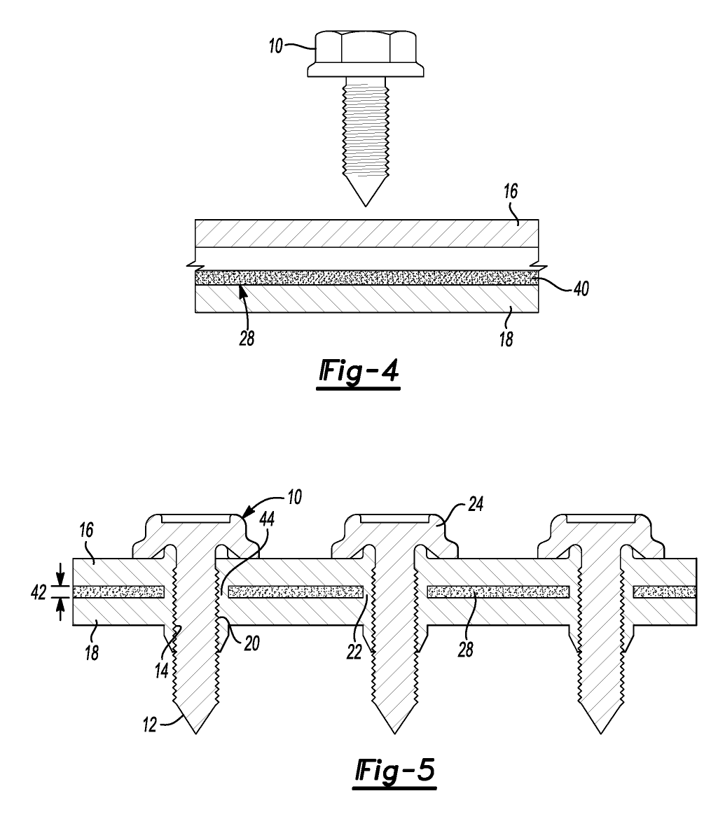

Referring to FIG. 4, a flow drill screw 10 is shown in position to be inserted into a first panel 16, or insertion panel, that differs from the first panel 16 shown in FIGS. 2-3 in that the first panel 16 does not define a clearance hole 30. The flow drill screw 10 is rapidly rotated and pressed into the first panel 16. The flow drill screw 10 displaces material from the first panel 16 on the upper side of the panel and on the lower side of the panel. The displaced material on the lower side of the panel displaces adhesive 28 applied to the second panel 18 when the flow drill screw 10 penetrates the first panel 16. The flow drill screw 10 continues through the adhesive 28 and the second panel 18. It should be understood that the adhesive 28 is applied as a continuous strip 40 of adhesive, and it can be applied to either the second panel 18 or the first panel 16.

Referring to FIG. 5, three flow drill screws 10 are shown joining the first panel 16 and a second panel 18 together with an adhesive 28. The flow drill screws 10 have each formed a hole 14 that extends through both of the panels 16 and 18. The hole 14 includes a thread 20 formed in the collar 22. The collar 22 extends through both panels and through the adhesive 28. The collar 22 is formed by the displaced metal from the first panel 16 and second panel 18. The large amount of material displaced from the first panel 16 and second panel 18 displaces the adhesive 28 from the continuous strip of adhesive shown in FIG. 4 and also forms an adhesive gap 42 of a desired thickness between the first panel 16 and the second panel 18.

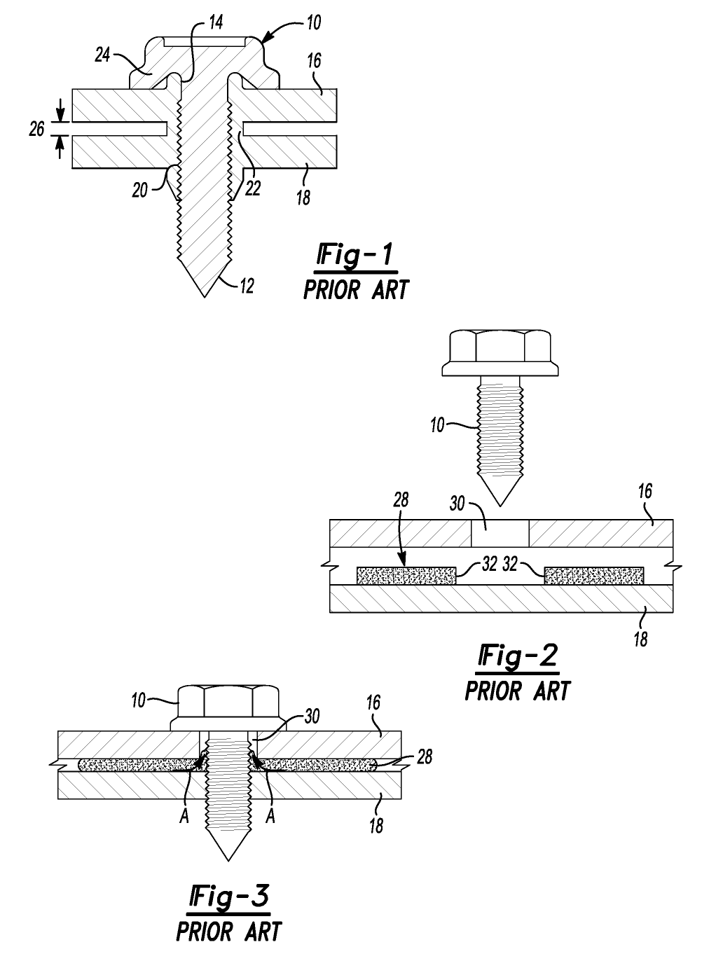

Based upon the size of the flow drill screw, the thickness and type of material forming the first panel 16 and second panel 18, a predictable adhesive gap 42 may be established by the amount of displaced material forming an intermediate collar portion 44 of the collar 22 between the first panel 16 and the second panel 18. The adhesive gap 42 is formed in the same manner as the objectionable gap 26 shown in FIG. 1 but is filled with the adhesive 28 from the continuous strip of adhesive 28.

The disclosed method utilizes the first panel 16 without the clearance hole 30 to assure that sufficient material is displaced by the flow drill screw 10 to form a collar 22 that creates the adhesive gap 42. The adhesive 28 is applied in a continuous line to either or both of the first panel 16 or the second panel 18 in the location where the flow drill screw 10 is inserted into the panels 16, 18. The collar 22 formed by insertion of the flow drill screw 10 displaces part of the adhesive 28 and transfers the adhesive to the adhesive gap 42.

The disclosed method eliminates the need to form a clearance hole 30 and also eliminates the need to apply the adhesive 28 in a series of strips 32. The method is simplified by the elimination of the above two steps. Further, the elimination of the clearance hole 30 prevents problems relating to contamination of the flow drill screw gun with adhesive 28. The objectionable gap 26 shown in FIG. 1 is converted to a desirable adhesive gap 42 that provides sufficient space for the adhesive 28 to provide a more efficient hybrid (i.e. mechanical and adhesive) joint between the panels in combination with the flow drill screw 10.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

1. A method of joining panels comprising:
selecting a first panel and a second panel;
applying an adhesive in a continuous strip between the first and second panels;
drilling a flow drill screw through the first panel, the adhesive and the second panel; and
forming a collar with material displaced by the flow drill screw that defines a bond gap for the adhesive between the first and second panels.

2. The method of claim 1 wherein the flow drill screw is inserted into a portion of the first panel that does not define a pre-cut hole.

3. The method of claim 1 wherein the first and second panels are aluminum sheet metal panels.

4. The method of claim 1 wherein the adhesive is a structural adhesive that is cured in an oven.

5. The method of claim 1 wherein during the step of forming a collar, material displaced by the flow drill screw moves the adhesive away from the flow drill screw and into the bond gap.

6. The method of claim 1 wherein the bond gap between the first and second panels has a depth that is controlled by formation of the collar.

7. The method of claim 1 wherein the collar extends from an insertion surface of the first panel, between the first and second panels and through an exit surface of the second panel.

8. An assembly comprising:
a first panel;
a second panel assembled against the first panel;
an adhesive deposit between the first and second panels
a flow drill screw drilled through the first panel, the adhesive deposit and the second panel; and
a collar formed around the flow drill screw that includes an intermediate collar portion having a height that sets a bond gap between the first and second panels for receiving the adhesive deposit.

9. The assembly of claim 8 wherein the intermediate collar portion separates the adhesive deposit from the flow drill screw.

10. The assembly of claim 8 wherein the first and second panels are aluminum sheet metal panels.

11. The assembly of claim 8 wherein the adhesive deposit is a structural adhesive.

12. The assembly of claim 8 wherein the bond gap between the first and second panels has a depth that corresponds to a length of the intermediate collar portion between the first and second panels.
